(19) United States
(12) Patent Application Publication
(10) Pub. No.: US 2020/0192075 A1
(43) Pub. Date: Jun. 18, 2020

(54) ILLUMINATED RETICLE SYSTEM WITH FRESNEL LENS

(71) Applicant: Leupold & Stevens, Inc., Beaverton, OR (US)

(72) Inventor: Martin KOORNNEEF, Beaverton, OR (US)

(73) Assignee: Leupold & Stevens, Inc., Beaverton, OR (US)

(21) Appl. No.: 16/719,784

(22) Filed: Dec. 18, 2019

Related U.S. Application Data
(60) Provisional application No. 62/799,993, filed on Feb. 1, 2019.
(60) Provisional application No. 62/781,390, filed on Dec. 18, 2018.

(51) Int. Cl. G02B 23/02; G02B 3/08; F41G 1/38; F41G 1/30

(52) U.S. Cl. CPC G02B 23/02; F41G 1/30; F41G 1/38; G02B 3/08

(57) ABSTRACT

An illuminated reticle system for use with an optical viewing device, such as a riflescope, that includes a light source, a transparent substrate carrying a reticle such as a diffraction grating, and a Fresnel lens interposed between the light source and an entry surface into the transparent substrate through which light from the light source propagates toward the reticle along a converging beam path. The Fresnel lens provides strong positive optical power in a very small, lightweight, and inexpensive package to thereby cause light diverging from the light source to converge toward the reticle, which then redirects at least some of the light toward a viewer along an optical path of the optical viewing device as a diverging bundle of output light to fill an exit pupil of the optical viewing device.

### RELATED APPLICATIONS

This application claims the benefit under 35 U.S.C. § 119(e) from U.S. Provisional Patent Application No. 62/781,390, filed Dec. 18, 2018 and U.S. Provisional Patent Application No. 62/799,993, filed Feb. 1, 2019, both of which are incorporated herein by reference.

### TECHNICAL FIELD

The field of the present disclosure relates to optical systems for producing an illuminated reticle or aiming mark, illuminated reticle systems, and to riflescopes, observation optics and other optical systems including such illuminated reticle systems.

### BACKGROUND

Illuminated reticles are commonly used in riflescopes and may also be used in other kinds of optical aiming devices, spotting scopes, binoculars, and other sports optics and observation optics. Several different devices, systems, and methods have been used to illuminate reticle features. All have varying degrees of output efficiency.

FIG. 1 is a cross-section elevation view illustrating the optical system of an exemplary riflescope 10 with an illuminated reticle system 12 according to the prior art, located at a front focal plane 14 of the riflescope 10 between an objective lens 16 and an erector lens system 18 thereof. An enlarged cross-sectional detail view of the illuminated reticle system 12 is provided in FIG. 2.

The most common illuminated reticle for riflescopes is created with an etch-and-fill method. This system includes a reticle feature etched in a surface of a glass substrate disc that is mounted at one of the internal focal planes of the scope. The etched reticle feature is filled with a white diffuse reflecting material (titanium oxide). The scattered light of a light source illuminating the feature will fill the exit pupil of a rifle scope creating a moderately bright aiming feature, but which will not be bright enough to stand out against a bright background.

One known way to increase the brightness is to replace the “etch-and-fill” reticle feature with a diffraction grating, consisting of a periodic structure that diffracts the incoming light into different orders, as is taught by European Patent Application Pub. No. EP 0 886 163 A1. By illuminating the grating with a defined wavelength, and at a specific angle, one of the orders can be made to travel down the optical axis of the riflescope creating a bright aiming feature.

One of the key characteristics of a diffraction grating is that the output angle of the diffracted light is dependent on the input angle and the wavelength of light. This means that out of a diverging cone of light from a single wavelength light source, only a very small portion would end up traveling down the riflescope towards the user. Also, the diffracted bundle of light rays will not diverge because no converging bundle of light is presented to the grating. This situation is depicted in FIG. 3, which is an enlarged view of the optical elements of FIG. 2. With reference to FIG. 3, a diverging cone of light 30 emanating from a light source 32 is directed at a grating 34 formed on a surface of one of two glass reticle discs 38, 40 that are optically bonded or optically coupled together. A small prism 42 is optically bonded or optically coupled to a lateral edge of the reticle discs 38, 40, to provide an entry surface 44 for the light 30 from light source 32. The light 30 is reflected from a rear surface 46 of reticle disc 40 via total internal reflection (TIR) toward grating 34. Because the input light is diverging, the grating 34 diffracts the illumination along a very narrow exit beam path 48 toward an eyepiece 50 (FIG. 1) of the riflescope 10. This causes the exit pupil of the riflescope to be under-filled by the reticle illumination, which would look to a user as if the illumination is shut off when the user's eye is moved away from the center of the exit pupil. This situation is problematic when using a riflescope having low optical power (low magnification) and a large exit pupil, and wherein a bright aiming dot or other illuminated aiming reticle is used for quick target acquisition. The time it takes a user to center their eye in the exit pupil and visually reacquire the illuminated reticle is unacceptable for the low power scope use scenario (e.g., close quarters tactical use) and undermines the benefit of having a large exit pupil.

U.S. Patent Application Pub. No. US 2006/0092507 A1 describes an illuminated reticle including an ellipsoidal mirror bonded to an edge of the reticle disc. The ellipsoidal mirror has two focal points—one where a light source is positioned, and the other focal point at a diffraction grating, such that the light converges toward the grating. The ellipsoidal mirror is costly; and even though the light source is mounted axially to the reticle cylinder (and parallel to the optical axis of the riflescope), the whole package is relatively large. When a reticle system of this type is used at a front focal plane of a riflescope and mounted at a distal end of a pivoting erector tube of the riflescope, the size of the illumination system package can undesirably limit the travel of the pivoting erector tube for elevation and windage adjustment.

European Patent Application Pub. No. EP 2 548 073 A1 describes the use of an aspheric lens with a simple coupling prism to create a beam of light that converges toward a grating formed on the glass reticle substrate. This design avoids the use of an ellipsoidal mirror, but requires an additional precision optical element that must be precisely aligned with the reticle substrate, and results in an even larger and heavier package than the one disclosed by US 2006/0092507 A1.

U.S. Patent Application Pub. No. US 2017/0248798 A1 describes variants on the illuminated reticle system of US 2006/0092507 A1, which include retroreflectors disposed along a light exit surface of the glass reticle substrate to reflect stray light back to the diffraction grating that forms the reticle, FIGS. 9 and 12 of US 2017/0248798 A1 disclose angled light entry surfaces that are ground into a lateral margin of the glass reticle substrate disc and perpendicular to the optical axis of a light source and a lens used, in place of the ellipsoidal mirror of other embodiments, to focus the light onto the diffraction grating.

The present inventor has recognized a need for further reduction of the size, weight, and cost of illuminated reticle systems, without sacrificing the illumination intensity or quality, and has invented improvements described herein.

### SUMMARY

An optical system for displaying a reticle in an optical viewing device, according to the present disclosure, includes a light source, a transparent substrate carrying a reticle, and an entry surface through which light from the light source propagates along an illumination beam path into the transparent substrate and onto the reticle, which redirects at least some of the light through a first major surface of the substrate and along an optical path of the optical viewing device toward a viewer. A Fresnel lens having a positive optical power is interposed in the illumination beam path between the light source and the transparent substrate, to thereby cause light diverging from the light source to converge toward the reticle.

The reticle is preferably formed by a diffraction grating on a surface of the transparent reticle substrate, but may be formed in other ways such as an etch-and-fill type reticle. The convergence of the beam of illumination directed at the reticle is preferably tailored by careful prescription of the Fresnel lens, so that light redirected by the reticle through the first major surface diverges to fill an exit pupil of the optical viewing device.

The transparent substrate may comprise one or more plates of material that is transparent to visible light and having parallel major surfaces, one of which is the first major surface through which the reticle illumination exits. The major surfaces of the transparent substrate are intersected by the optical path of the optical viewing device and are preferably oriented substantially perpendicular thereto. The entry surface is preferably offset from the optical path of the optical viewing device so as to be positioned outside of a portion of the substrate viewable with the optical viewing device, and may consist of a polished flat surface formed directly in the transparent substrate at an oblique angle relative to the major surfaces. Alternatively, the entry surface may be formed in a coupling prism that is optically bonded to a flat surface formed in a lateral surface of the transparent substrate that connects the parallel major surfaces. The parallel major surfaces of the transparent substrate may be connected by a generally cylindrical lateral surface having a surface area less than the sum of the surface areas of the parallel major surfaces.

The transparent substrate may include two transparent plates of glass or other transparent material optically bonded together. In such embodiments, the reticle, such as a diffraction grating may be formed on one of the two facing major surfaces of the plates before they are bonded together. If two transparent plates are used, the entry surface may be formed in either one of the glass plates, or both of the glass plates.

The Fresnel lens is preferably configured as a condenser lens with fixed conjugates at the light source and at the path distance to the reticle. The Fresnel lens may be positioned so that its optical axis is perpendicular to the entry surface and centered on the light source. Alternatively, the Fresnel lens may be positioned with its optical axis offset relative to the emission axis of the light source; or at an oblique angle relative to the entry surface, or both, in order to achieve a shaped beam that at least partly counteracts shaping effects imparted by a total internal reflection (TIR) off the first major surface of the transparent substrate before the light reaches the reticle and the angle of incidence at the reticle, to thereby improve the size and shape of the illumination spot at the reticle.

The Fresnel lens may include a first Fresnel lens surface facing toward the light source and a second Fresnel lens surface facing toward the entry surface, and may have a different number of grooves on the first and second Fresnel surfaces. In a typical riflescope reticle implementation, the Fresnel lens may have an effective focal length of between approximately 1 mm and approximately 5 mm, a diameter greater than approximately 3 mm, and a thickness of less than approximately 3 mm or less than approximately 1.5 mm, and preferably between 0.5 mm and 1.0 mm. The Fresnel lens preferably has an f-number of less than f/1.0 and more preferably between f/0.3 and f/0.8 or less than approximately f/0.5, making it a very “fast” lens. The Fresnel lens may be aspheric to reduce spherical aberration.

Additional aspects and advantages will be apparent from the following detailed description of preferred embodiments, which proceeds with reference to the accompanying drawings.

### BRIEF DESCRIPTION OF THE DRAWINGS

FIG. 1 is a side sectional view of a riflescope including a reticle located at a front focal plane, illustrating one possible environment of use for the invention;

FIG. 2 is an enlarged sectional detail view of an illuminated reticle system of the riflescope of FIG. 1 identified as detail 2-2 in FIG. 1;

FIG. 3 is a sectional schematic view depicting an illuminated reticle system and light path, and illustrating the effect of diverging illumination directed at a diffraction grating forming a reticle of the system;

FIG. 4. is a sectional schematic view depicting an illuminated reticle system according to an embodiment of the invention, taken along section lines 4-4 of FIG. 5;

FIG. 5 is a schematic elevation view of the illuminated reticle system of FIG. 4 as viewed from an objective-facing side of the reticle system along an optical axis of a riflescope within which the illuminated reticle is installed; and

FIG. 6 is a sectioned pictorial view of an exemplary Fresnel lens component of the illuminated reticle of FIGS. 4 and 5.

### DETAILED DESCRIPTION OF PREFERRED EMBODIMENTS

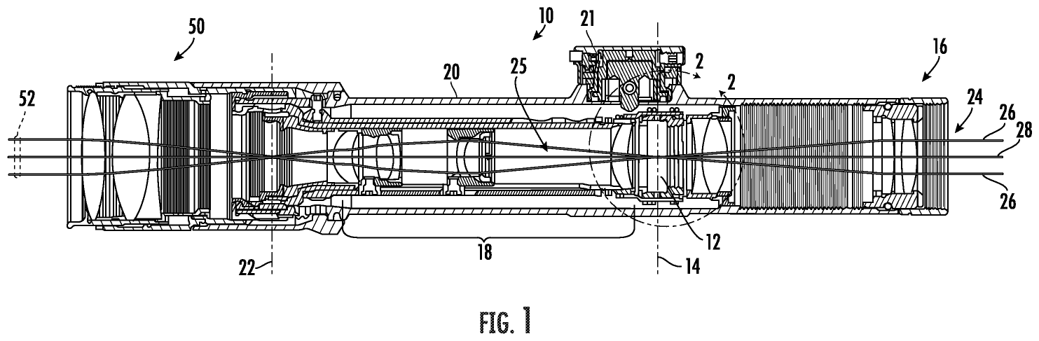

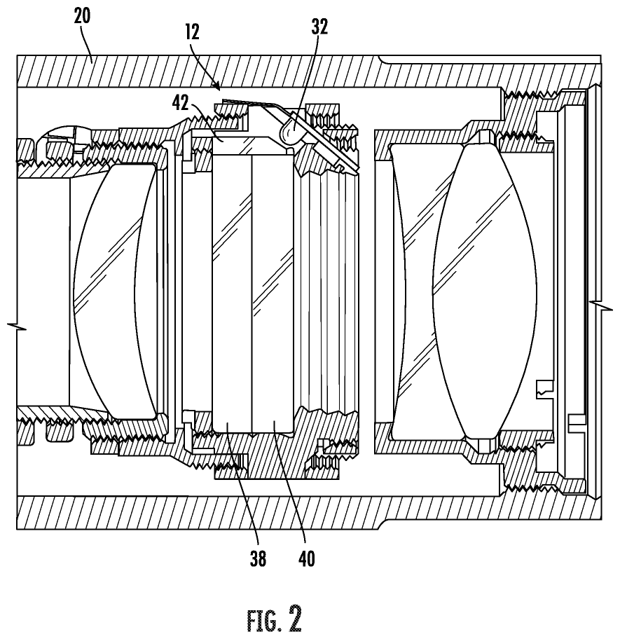

FIG. 1 shows a side sectional view of an exemplary riflescope 10 with a reticle 12 located at a front focal plane 14 between an objective lens 16 of the riflescope 10 and an erector lens system 18. In some other riflescopes (not illustrated), the reticle 12 may be placed at a rear focal plane 22 between erector lens system 18 and an eyepiece 50 of riflescope 10. And in still other riflescopes (not illustrated), a first reticle may be located at front focal plane 14 and a second reticle may be located at rear focal plane 22, and may be used for alternate purposes, or in combination/coordination. Erector lens system 18 is pivotally mounted to a tubular housing 20 of riflescope 10 and movable in response to adjustment of an elevation adjustment knob 21 and a windage adjustment knob (not shown, but would be extending along an axis into the plane of the page), to adjust a vertical and/or horizontal position of the reticle 12 relative to an image of a distant target formed at the focal plane, as is well known in the art.

With reference to FIG. 1, an on-axis bundle of light rays 24 propagating along an optical path 25 of riflescope 10 is represented as top and bottom marginal rays 26 and a center ray 28 coincident with an optical axis of objective lens 16. Light from a distant object (not illustrated) enters riflescope 10 from the right as a collimated bundle of light rays 24 refracted by objective lens 16 and coming to a focus at a first focal plane (front focal plane 14), then traveling through erector lens system 18 and coming to focus again at a second focal plane (rear focal plane 22). Then light diverging from rear focal plane 22 is collimated by eyepiece 50 and exits the scope to form an exit pupil 52 spaced rearwardly of eyepiece 50.

As noted previously, reticle 12 may be located at either of the front and rear focal planes 14, 22, allowing the user to simultaneously observe the reticle mark(s) and an image of the distant object formed at the focal plane. The reticle markings may function as aiming point(s) for superimposing over a desired target location to aim a weapon (not shown) to which riflescope 10 is conventionally mounted. In some optical devices, such as optical viewing devices that are not aiming devices, an illuminated reticle may be utilized for other purposes, such as range estimation or for spotting the deviation of a hit relative to the target. Reticle markings can range from a simple central dot or crosshair, to more complicated collections of lines, dots, graphics, and other features used for functions like bullet drop compensation, wind hold compensation, information display, or range estimation.

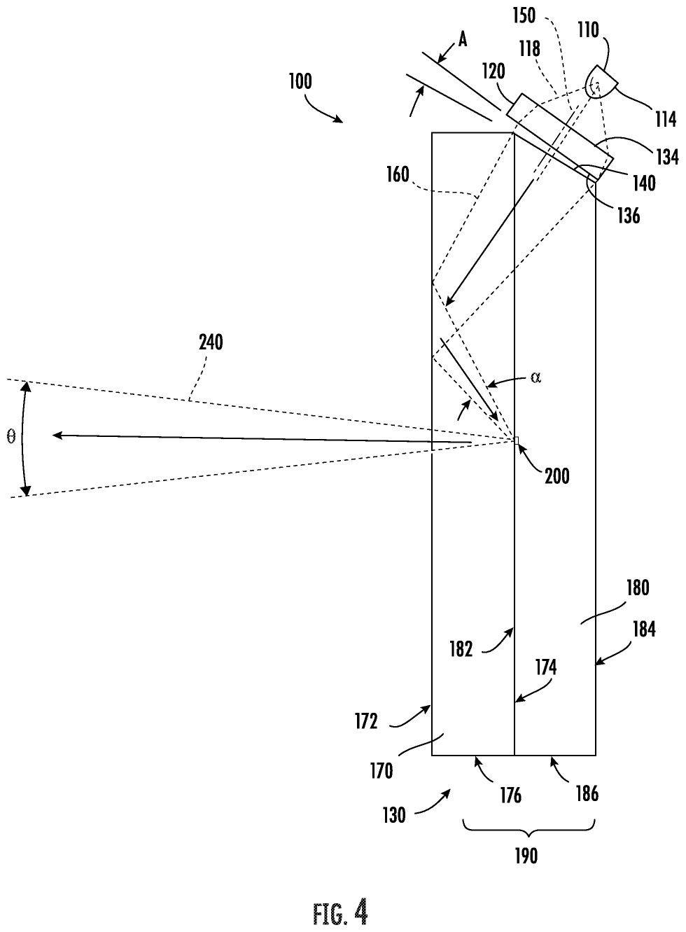

To fill the exit pupil 52 of riflescope 10, the divergence of the bundle of light output from the illuminated reticle feature needs to approximately match or exceed the divergence of the bundle of light rays 24 as they exit the reticle 12. To achieve divergence of the light output from a diffraction grating and fill the exit pupil 52, the light directed at the diffraction grating must be converging, as illustrated in FIG. 4, discussed in detail below.

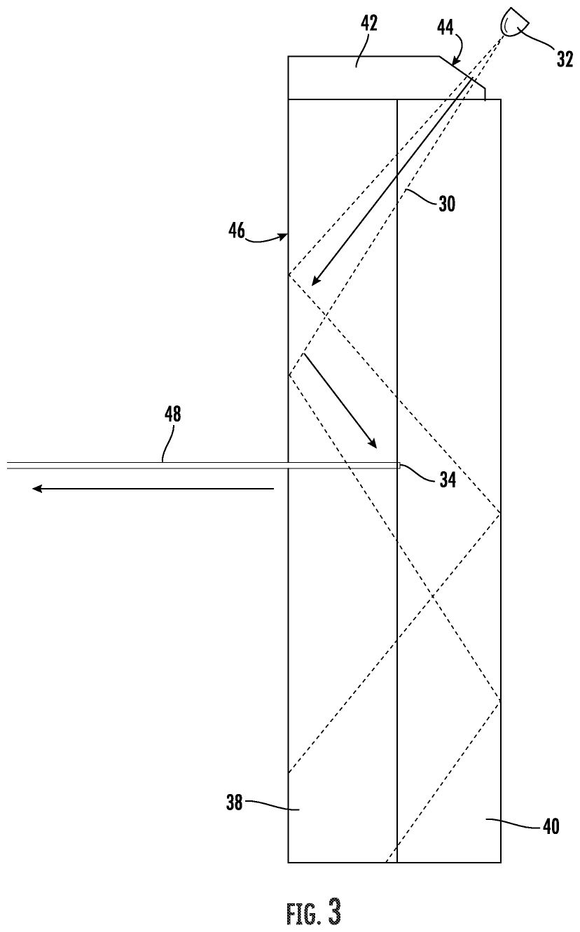

However, light emitting diode (LED) light sources typically utilized in illuminated reticle systems create a diverging beam of light as illustrated in FIG. 3, discussed above. To collect the diverging light from such LED light sources and cause them to converge toward a focal point at the reticle requires the use of a lens or mirror system with strong positive surfaces and a relatively large diameter. The size and cost of such conventional lenses or mirrors are prohibitive for the reasons discussed previously.

The present inventor has discovered that it is advantageous to collapse the relay optics of a condenser lens system into a single Fresnel lens. This makes it possible to fit a very powerful positive lens having a relatively large diameter in a very small space, and thereby use a greater amount of the diverging bundle of light emanating from the light source than is possible with lenses or mirrors having a smaller diameter and/or spaced farther from the light source.

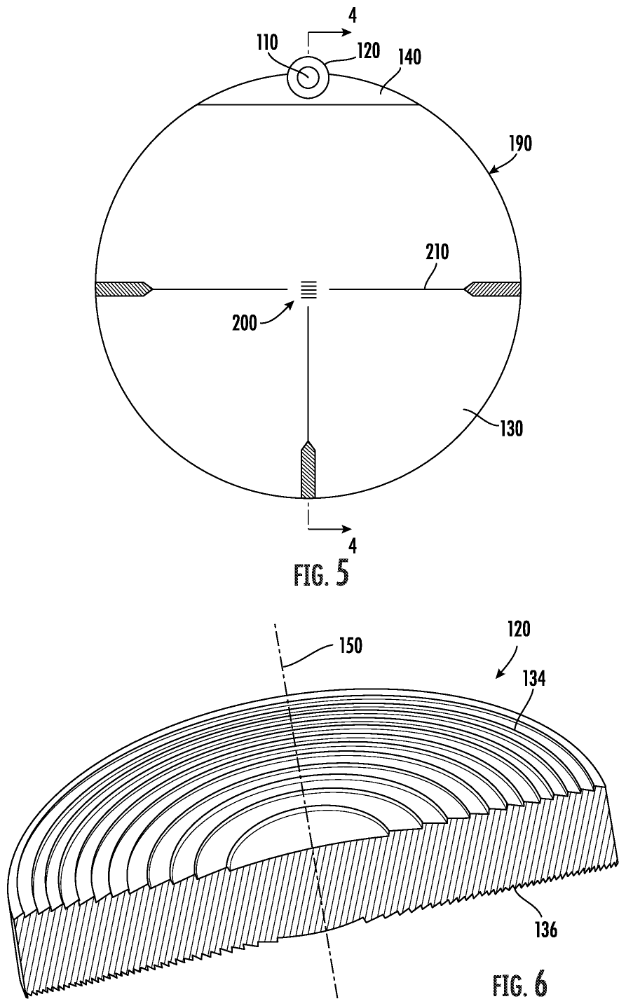

FIG. 4 is a schematic sectional elevation view of an illuminated reticle system 100, according to a preferred embodiment, taken along section lines 4-4 of FIG. 5, which is a schematic elevation view of illuminated reticle system 100 as viewed from an objective-facing side of the reticle system 100, as would appear along an optical axis 28 (FIG. 1) of a riflescope 10 within which the illuminated reticle system 100 may be installed. With reference to FIGS. 4 and 5, illuminated reticle system 100 includes a light source 110, such as a monochromatic or narrowband LED, eye-safe laser diode, or other suitable light source that occupies little volume within the housing 20 of riflescope 10. In the embodiment illustrated, light source 110 includes an LED with a dome lens 114 for collecting light from the diode and directing a diverging beam of light 118 toward a Fresnel lens 120 interposed in the beam path between light source 110 and a transparent substrate 130 of the reticle system 100. In other embodiments, the LED may be a surface-mounted LED (SMD LED), chip-on-board (COB LED), or other light source lacking a dome lens, which may allow the light source to be located closer to Fresnel lens 120 to further reduce the size of the overall package. Light source 110 need not constitute an electrically powered light emitting device. For example, light source 110 may alternatively consist essentially of a passive ambient light collector, such as a fiber optic collector including a light pipe or windings located outside riflescope 10 and a segment which extends through housing 20 with an end of the optical fiber aimed at Fresnel lens 120. Ambient light collected by the fiber optic collector is propagated down the optical fiber to be emitted at the end of the optical fiber proximate Fresnel Lens 120.

The diverging beam of light 118 emanating from light source 110 enters a first Fresnel lens surface 134 of Fresnel lens 120 facing toward light source 110 and is refracted towards a second Fresnel lens surface 136 facing toward an entry surface 140 of transparent substrate 130. Fresnel lens 120 causes the light from light source 110 to converge as it propagates along an illumination beam path 160 exiting Fresnel lens 120 and through entry surface 140 into transparent substrate 130.

Transparent substrate 130 may comprise one or more plates of glass, plastic, or other transparent material, with the term “transparent” meaning that the material is transparent to visible light and causes no significant scattering or diffusion. In the embodiment illustrated in FIG. 4, transparent substrate 130 includes a first glass plate 170 having parallel first and second major surfaces 172, 174, respectively, and a second glass plate 180 having parallel third and fourth major surfaces 182, 184. The second major surface 174 of the first glass plate 170 is optically bonded to the third major surface 182 of the second glass plate 180 with an optical bonding material that preferably has substantially the same or similar index of refraction as the first and second glass plates 170, 180. Suitable optical bonding materials may include adhesives, cementing, or other means of optically coupling the first and second glass plates 170, 180 at the respective second and third major surfaces 174 and 182.

The first and second major surfaces 172, 174 are connected by a first lateral surface 176, and the third and fourth major surfaces 182, 184 are connected by a second lateral surface 186. The first and second lateral surfaces 176, 186 are preferably generally cylindrical, it being understood that one or both may be interrupted by the planar entry surface 140 or another flat surface formed therein to facilitate transmission of the illumination into transparent substrate 130. The first lateral surface 176 preferably has a surface area that is substantially less than the sum of the surface areas of the first and second major surfaces 172, 174. Similarly, the second lateral surface 186 preferably has a surface area that is substantially less than the sum of the surface areas of the third and fourth major surfaces 182, 184. If two reticle plates are utilized and have major surfaces that are the same size, then the first and second lateral surfaces 176, 186 may together form a combined lateral surface 190 of the transparent substrate 130, wherein the total surface area of the combined lateral surface 190 may be less than the sum of the first and fourth major surfaces 172 and 184. The major surfaces 172, 174, 182, and 184 of the transparent substrate 130 are preferably intersected by the optical path (as depicted in FIG. 1 by light rays 24) of the riflescope 10 or other optical viewing device, and the major surfaces 172, 174, 182, and 184 are preferably oriented substantially perpendicular to the optical path, allowing for deviations in perpendicularity due to pivoting movement of the illuminated reticle system 100 along with a pivot tube of the pivoting erector lens system 18, to which the illuminated reticle system 100 may be mounted, as illustrated in FIG. 1.

A reticle 200, which may include a diffraction grating (e.g., a reflective grating, ruled grating, or blazed grating), etch-and-fill reticle structure, holographic diffraction grating, or other structure may be formed on second major surface 174 or on third major surface 182, or both, or which may be embedded within transparent substrate 130, such as within a single carrier plate of transparent material. The term “reticle” as used herein should be understood broadly as encompassing any of a variety of structures or optical elements that, when illuminated (and in some embodiments also when not illuminated), will generate a display of a mark or marks viewable by the user of the riflescope 10 or other optical viewing device, and may include elements that reflect, diffract, or otherwise redirect reticle illumination to form an image of a mark in the eye of the viewer. The term “reticle” is therefore not limited to features directly visible on the surface of transparent substrate 130. As illustrated in FIG. 5, the illuminated reticle 200, may be aligned with one or more non-illuminated reticle marks 210, such as an opaque reticle crosshair or stadia lines, so that the illuminated and non-illuminated reticles 200, 210 together form a composite reticle for good visibility in both bright daylight and low-light conditions. For illustration purposes, the size of reticle 200 in FIGS. 4 and 5, and the grating lines depicting reticle 200 in FIG. 5, are greatly exaggerated.

The converging beam of illumination 160 reflects off first major surface 172 via TIR and converges to a focal point at or very near reticle 200. The angle of incidence, the wavelength of the illumination, the period of the diffraction grating, and potentially other aspects of the design, are selected, utilizing well-known optical principles relating to diffraction gratings, to produce a first order diffraction from the grating having an output angle that propagates along an output path represented by a bundle of output light 240 for viewing via riflescope 10 or another optical device (e.g., through eyepiece 50), to thereby appear as an illuminated reticle or aiming mark. The bundle of output light 240 comprising the first order diffraction is preferably substantially perpendicular to first major surface 172 and has a diverging beam path having a divergence angle θ that fills exit pupil 52 (FIG. 1) of riflescope 10 or otherwise is large enough to fill a stop of the riflescope 10 if located between reticle system 100 and the viewer's eye, such as eyepiece 50, for example. To maximize luminance of the reticle feature as perceived by the user, the divergence of the bundle of output light 240 produced by the illuminated reticle 200 should not greatly exceed the divergence of light rays 24 or the size of a stop, if located between reticle system 100 and the viewer's eye. An output divergence angle θ of output light 240 is a function of the convergence angle of the input illumination beam 160. For example, the output divergence angle θ may be the same as the angle of convergence angle α of input illumination beam 160. Because the diverging bundle of output light 240 is large enough to fill the exit pupil 52 it is designed for, it eliminates the need to visually acquire the illuminated feature in the exit pupil 52 (e.g., by centering the eye in the exit pupil 52) and will make target acquisition quicker.

Entry surface 140 is preferably offset from the optical path 25 so as to be positioned outside of a region of transparent substrate 130 viewable via riflescope 10. Entry surface 140 may be formed in various ways and located in various places on transparent substrate 130, as is taught for example by US 2017/0248798 A1. For example, entry surface 140 may consist of a polished flat surface formed directly in the transparent substrate 130 at an oblique angle relative to the major surfaces. Entry surface 140 may be a flat surface that is ground and polished along a top portion of second lateral surface 186 of second glass plate 180. In another embodiment (not illustrated), the entry surface 140 may be a flat surface formed in first lateral surface 176 at an oblique angle relative to first major surface 172 and angled for an illumination beam path that is aimed directly at reticle 200 and does not reflect off any of the major surfaces 172, 174, 182, 184. Alternatively, the entry surface may be formed in a coupling prism (such as coupling prism 42 of FIG. 3) that is optically bonded to a flat formed in a lateral surface 176, 186, or 190 of the transparent substrate 130.

Fresnel lens 120 is preferably configured as a condenser lens with fixed conjugates at the light source 110 and at the path distance to reticle 200. An exemplary Fresnel lens 120 is depicted in FIG. 6, having opposite first and second Fresnel lens surfaces 134, 136 comprising a set of concentric grooves. Opposing first and second Fresnel lens surfaces 134, 136 may be generally parallel to each other (save for the shape of grooves and ridges) and may have coincident optical axes, illustrated by optical axis 150 of Fresnel lens 120. Alternatively, first and second Fresnel lens surfaces 134, 136 may be non-parallel, for example angled as a wedge, to shape the beam of illumination 160 to achieve a desired illumination spot size and shape at reticle 200, which may involve at least partly counteracting spot-shaping effects of the TIR reflection at first major surface 172 and the incident angle of illumination at reticle 200.

Fresnel lens 120 may be formed of glass, plastic, or another transparent material and made by any of various methods. For example, Fresnel lens 120 may be formed by diamond turning or molding a blank of optical material, such as polycarbonate, acrylic, or other polymers and blends thereof. Other methods of manufacture may also be possible. Fresnel lens 120 may be circular in shape or may be formed, cut, ground, or otherwise shaped to include notches, flats, or a polygonal shape, such as square or trapezoidal, which may help to precisely orient and position Fresnel lens 120 in a lens holder (not illustrated) relative to light source 110 or other elements of illuminated reticle system 100.

Fresnel lens 120 may be positioned so that its optical axis 150 is perpendicular to entry surface 140 and centered on the light source. However, as illustrated in FIG. 4 the Fresnel lens 120 may be positioned with its optical axis 150 at an inclined angle A, which may be between 1 and 10 degrees relative to entry surface 140, to tune the shape of the size and/or shape of the illumination spot at reticle 200 (essentially the shape of the projected image of light source 110) to maximize brightness of the illuminated reticle feature. To improve the illumination spot size and shape at reticle 200, the optical axis 150 of Fresnel lens 120 may also be slightly offset relative to the emission axis of light source 110 in order to achieve a slightly oval shaped beam of illumination 160 that compensates for and/or at least partly counteracts elongation or shaping effects imparted by of the TIR off first major surface 172 and the resultant angle of incidence of light onto reticle 200 relative to the plane of the major surface 174 or 182 in which reticle 200 is formed.

As depicted in FIGS. 4 and 6, Fresnel lens 120 may include a first Fresnel lens surface 134 facing toward light source 110 and a second Fresnel lens surface 136 facing toward entry surface 140. Fresnel lens 120 may have a different number of grooves on the first and second Fresnel lens surfaces 134 and 136. In some embodiments a greater number of grooves are formed in second Fresnel lens surface 136 than in first Fresnel lens surface 134, or vice versa. For example, Fresnel lens 120 may have 13 grooves on first Fresnel lens surface 134 and 39 grooves in second Fresnel lens surface 136. In one embodiment, the number of grooves on second Fresnel lens surface 136 may be greater than the number of grooves on first Fresnel lens surface 134. In some alternative embodiments, a diffuser (not illustrated) may be placed between light source 110 and Fresnel lens 120 to diffuse, homogenize and enlarge the spot of light imaged at reticle 200, which may be useful with a relatively large illuminated reticle, such as a horseshoe reticle. In still other alternative embodiments (not shown) a Fresnel lens structure may be formed in only one of the surfaces of Fresnel lens 120, with the other surface being a planar surface. And in still another embodiment, a Fresnel lens 120 may be formed directly in entry surface 140.

In a typical riflescope implementation, Fresnel lens 120 may have an effective focal length of between approximately 1 mm and approximately 5 mm, a diameter greater than approximately 3 mm, and a thickness of less than approximately 3 mm or less than approximately 1.5 mm, and preferably between 0.5 mm and 1.0 mm. Fresnel lens 120 may be designed as a very “fast” lens in a very short package of relatively large diameter, for example having an f-number of less than about f/1.0 and more preferably between f/0.3 and f/0.8, Fresnel lens 120 may be designed with aspheric surfaces to counteract spherical aberration. The fast design of Fresnel lens 120 improves light collection and allows light source 110 to be positioned very close to Fresnel lens 120 (for example, less than approximately 5 mm from first Fresnel lens surface 134, and more preferably between approximately 1 mm and approximately 4 mm from first Fresnel lens surface 134) while focusing the light at or near reticle 200.

It will be obvious to those having skill in the art that many changes may be made to the details of the above-described embodiments without departing from the underlying principles of the invention. The scope of the present invention should, therefore, be determined only by the following claims.

1. An optical system for displaying a reticle in an optical viewing device, comprising:
a light source;
a transparent substrate carrying a reticle, and an entry surface through which light from the light source propagates along an illumination beam path into the transparent substrate and onto the reticle, which redirects at least some of the light through a first major surface of the substrate and along an optical path of the optical viewing device toward a viewer; and
a Fresnel lens interposed in the beam path between the light source and the transparent substrate, the Fresnel lens having a positive optical power so as to cause light from the light source to converge toward the reticle.

2. The optical system of claim 1, wherein the reticle includes a diffraction grating.

3. The optical system of claim 2, wherein light redirected by the diffraction grating through the first major surface diverges to fill an exit pupil of the optical viewing device.

4. The optical system of claim 1, wherein the entry surface is a polished flat surface formed directly in the transparent substrate at an oblique angle relative to the first major surface.

5. The optical system of claim 1, wherein the entry surface is formed in a coupling prism that is optically bonded to a lateral surface of the transparent substrate.

6. The optical system of claim 1, wherein the first major surface of the transparent substrate is intersected by the optical path of the optical viewing device and the entry surface is offset from the optical path of the optical viewing device so as to be positioned outside of a portion of the substrate viewable with the optical viewing device.

7. The optical system of claim 1, wherein the transparent substrate includes a first glass plate having parallel major surfaces, one of which is the first major surface and the other of which is a second major surface, the first and second major surfaces being connected by a generally cylindrical lateral surface having a surface area less than the sum of the surface areas of the first and second major surfaces, and the first and second major surfaces oriented substantially perpendicular to and intersected by the optical path of the optical viewing device.

8. The optical system of claim 7, wherein the transparent substrate includes a second glass plate optically bonded to the first glass plate, the second glass plate having parallel third and fourth major surfaces, and the third major surface being optically bonded to the second major surface of the first glass plate, the reticle being formed on the second major surface or the third major surface.

9. The optical system of claim 8, wherein the reticle includes a diffraction grating formed in the second major surface.

10. The optical system of claim 8, wherein the reticle includes a diffraction grating formed in the third major surface.

11. The optical system of claim 8, wherein the entry surface is formed in the second glass plate.

12. The optical system of claim 8, wherein the entry surface is at least partly formed in the first glass plate.

13. The optical system of claim 1, wherein the entry surface is perpendicular to an optical axis of the Fresnel lens.

14. The optical system of claim 1, wherein the entry surface is not perpendicular to an optical axis of the Fresnel lens.

15. The optical system of claim 1, wherein the light source is positioned off of an optical axis of the Fresnel lens.

16. The optical system of claim 1, wherein the light entering the transparent substrate is reflected off the first major surface of the transparent substrate via TIR before converging toward the reticle.

17. The optical system of claim 1, wherein the Fresnel lens has an effective focal length of between 1 mm and 5 mm.

18. The optical system of claim 1, wherein the Fresnel lens has fixed conjugates.

19. The optical system of claim 1, wherein the Fresnel lens has a diameter greater than 3 mm and a thickness of less than 3 mm.

20. The optical system of claim 1, wherein the Fresnel lens has an f-number of less than f/1.0.

21. The optical system of claim 1, wherein the Fresnel lens is a condenser lens.

22. The optical system of claim 1, wherein the Fresnel lens focuses the light at the reticle.

23. The optical system of claim 1, wherein the Fresnel lens is aspheric.

24. The optical system of claim 1, wherein the Fresnel lens includes a first Fresnel lens surface facing toward the light source and a second Fresnel lens surface facing toward the entry surface.

25. The optical system of claim 24, wherein each of the first and second Fresnel lens surfaces includes a plurality of circular grooves, and the quantity of circular grooves of the first Fresnel lens surface is different from the quantity of circular grooves of the second Fresnel lens surface.

26. The optical system of claim 25, wherein the quantity of circular grooves of the second Fresnel surface is greater than the quantity of circular grooves of the first Fresnel surface.

27. The optical system of claim 1 wherein the optical viewing device is a riflescope, and the reticle provides a visible aiming mark for aiming a weapon on which the riflescope is mounted.
